(19) United States
(12) Patent Application Publication
(10) Pub. No.: US 2005/0085185 A1
(43) Pub. Date: Apr. 21, 2005

(54) Method and apparatus for focusing sound

(76) Inventor: Steven Craig Patterson, Whitneyville, ME (US)

Correspondence Address: Steven C. Patterson, 106 South Main Street, Whitneyville, ME, 04654-4232, US

(21) Appl. No.: 10/680,741

(22) Filed: Oct. 6, 2003

(51) Int. Cl. H04H 7/00

(52) U.S. Cl. 455/3.06

(57) ABSTRACT

A method and apparatus for transmitting sounds which originate close to a site under study, while sharply attenuating sounds originating farther away. A reference transducer 40 is positioned as close as possible to the site under study. Three or more satellite transducers 38D-G are positioned on a circle 24 centered on the reference transducer, such that they divide the circle into equal arcs. The average signal of the satellite transducers, or a portion thereof, is subtracted from the signal of the reference transducer. The resulting difference signal may be amplified and/or filtered prior to being transduced to sound by speakers. Subtraction of the signals results in a focusing effect. Sounds which originate close to the reference transducer are preserved, while those which originate farther away are sharply attenuated. The focusing effect increases modestly with frequency. Sounds which originate at predictable locations in relation to the transducers are eliminated almost completely, a feature which enables the user to listen to the sounds of two juxtaposed sound sources, one at a time. The method disclosed offers greater distance selectivity at all frequencies than is possible using the prior art, and is suitable for use when the sounds to be discriminated are separated from the sensing means by an interface.

### FEDERALLY SPONSORED RESEARCH

Not applicable

### SEQUENCE LISTING OR PROGRAM

Not applicable

### BACKGROUND OF THE INVENTION

1. Field of Invention

This invention relates to the field of sound, more specifically to methods of selectively transmitting sound from one source, while rejecting sound from other sources.

2. Description of Prior Art

We live in a noisy society. It is often necessary to identify and characterize sound from a source of interest, despite a din of competing sounds. The competing sounds do not have to be particularly loud to make this task difficult, as long as they are of the same order of magnitude as those under study. Such is the case in medical stethoscopy, where contaminating sounds may obscure subtle signs of disease, and delay diagnosis and treatment.

Under most circumstances, assistive technology is not available, and we simply do our best to hear. We move closer to the source of the sound of interest, and away from other sound sources, taking advantage of the attenuation of sound with distance. We cock an ear toward the source, and plug the other ear, to benefit from the directional selectivity of a single ear. We cup a hand behind the ear to provide some amplification. And we mentally “tune in” to the sound's unique frequency distribution, to distinguish it from background noise.

Prior art technology uses the same basic techniques.

Distance Selectivity

Velocity or pressure-gradient microphones respond to particle velocity, thus differentiating between sounds from near and distant sources. Noise-cancelling microphones typically incorporate two transducers, spaced a few inches apart and connected in antiphase. Sounds which originate closer to one transducer attenuate en route to the farther transducer, and are only partially cancelled. Those coming from a distance affect both transducers more equally, and are more completely cancelled. Cancellation increases with wavelength, resulting in a falling bass response.

The two-transducer noise-cancelling method is subject to a comb filter effect. Frequencies which originate a whole number of wavelengths farther from one transducer than the other reach them in phase, and are completely cancelled. Frequencies which reach the antiphase transducers 180° out-of-phase, in contrast, augment one another. Alternating peaks of cancellation and augmentation produce a comb filter effect.

Newer noise-cancelling microphones have a diaphragm which is fully exposed to sounds of interest on one side, and exposed to the environment through an aperture in the case on the other side. The net sound pressure on the diaphragm is converted to an electrical impulse. The size of the aperture is adjusted to maximize the cancellation of contaminating environmental noise.

Directional Selectivity

Early cone-shaped hearing aids provided some directional selectivity, as well as amplification. Sound waves traveling toward the user along the cone's axis were efficiently funneled into the ear canal, while those striking the cone at other angles were not. Cones, baffles, and reflectors are used in other applications to direct sound waves toward or away from a sensing point, and sound-absorbing materials are used to reduce unwanted noise. Good directionality is achieved with a parabolic acoustic mirror, which reflects sound to a microphone facing the mirror at its focal point. Output falls for wavelengths longer than the reflector diameter, or shorter than the diameter of the microphone diaphragm.

Microphones exhibit a directional response in their pickup characteristics. At low and middle frequencies, omnidirectional microphones are equally sensitive to sound in all directions. However, at wavelengths shorter than the diameter of the diaphragm, diffraction of sound to the rear of the microphone diminishes, and the unit becomes increasingly directional. Ribbon microphones are sensitive to sound from the front and rear, but insensitive to sound from the sides. Cardioid microphones are sensitive to sound from the front, and far less sensitive to sound from the sides and rear. Like omnidirectional microphones, their directivity is greater at higher frequencies.

Zoom microphones are even more axis-selective. They consist of two cardioid microphones placed one behind the other and connected in antiphase. A frequency-dependent phase shifter is configured so that sounds from the front are reinforced, while side-propagated sound is cancelled. Directivity decreases at low frequencies.

Interference tube microphones have a similar polar response. These consist of an open-ended tube, with a series of holes or slots along one side, positioned in front of a microphone. The paths to the microphone, through the tube's open end and side fenestrations, are of equal length only for sound waves which originate along the tube's axis. Such waves arrive in phase, and are reinforced. Sound waves travelling these different paths from other sites arrive at the microphone out-of-phase, and are cancelled. The band of cancellation, and of high directivity, encompasses all frequencies with wave lengths more than double the tube length.

Laser interferometers can detect minute movements of reflective surfaces from great distances. In the absence of other causes, vibrations of such surfaces reflect the sound energy impinging on them. A laser beam may thus travel through a noisy environment, and be used to eavesdrop on a conversation taking place behind a closed window.

Frequency Selectivity

As noted, many of the devices and methods discussed above are selective only within certain frequency bands. When the frequency distribution of the sound of interest differs from that of competing sounds, the frequency responses of these devices and methods may be exploited to differentiate the sounds. In addition, filters may be used to pass selected frequencies, while rejecting others.

Combinations

Many devices use these techniques in combination. Cones or baffles are commonly used to direct sound from a selected source to a transducer. In some devices, one transducer is configured to primarily sense background noise, and its signal, or a (sometimes digitally-correlated) portion thereof, is subtracted from that of a second transducer. The resulting difference signal may then be amplified and filtered.

Problems Identified in the Prior Art

Despite improvements in the prior art, several problems remain:
(a.) The degree to which the prior art discriminates between sounds originating near a site of interest, and sounds originating farther away, is unsatisfactory for certain applications (e.g. conducting an interview in a noisy crowd).
(b.) The prior art primarily addresses sounds transmitted through a uniform medium (e.g. air) directly from their sources. These methods are not well suited for selectively sensing sounds through an interface (e.g. a patient's skin).
(c.) The two-transducer noise-cancelling method is subject to a comb filter effect.
(d.) The selectivity of many of the devices and methods in the prior art is diminished or lost at certain frequencies. The distance selectivity of the two-transducer noise-canceling microphone, for example, is lost at low frequencies.

### BRIEF SUMMARY OF THE INVENTION

Objects and Advantages

Accordingly, several objects and advantages of the present invention are:
(a.) to selectively transmit sound originating near a site of interest, while rejecting sound originating farther away, with greater discrimination than is possible with the prior art;
(b.) to selectively transmit sound from one source, while rejecting sound from other sources, even when the sensing means is separated from the sound sources by an interface;
(c.) to substantially reduce the comb filter effect;
(d.) to accomplish the foregoing objects throughout the frequency range of human hearing.
   Further objects and advantages will become apparent from a consideration of the ensuing description and drawings.

### SUMMARY

The present invention is a method and apparatus for transmitting sounds originating close to a site, while sharply attenuating sounds originating farther away. A reference transducer is positioned as close as possible to the site under study. Three or more satellite transducers are positioned on a circle centered on the reference transducer, such that they divide the circle into equal arcs. The average signal of the satellite transducers, or a portion thereof, is subtracted from the signal of the reference transducer. The resulting difference signal may be amplified and/or filtered prior to being transduced to sound by speakers.

Subtraction of the signals results in a focusing effect. Sounds which originate close to the reference transducer are preserved, while those which originate farther away are sharply attenuated. The focusing effect increases modestly with frequency, but is strong even at 16 Hz, the lower limit of human hearing. Sounds which originate at predictable locations in relation to the transducers are eliminated almost completely, a feature which enables the user to listen to the sounds of two juxtaposed sound sources, one at a time.

The method disclosed offers greater distance selectivity at all frequencies than is possible using the prior art. It is suitable for use when the sounds to be discriminated are separated from the sensing means by an interface.

### BRIEF DESCRIPTION OF THE DRAWINGS

FIG. 1 is a graphical illustration of the theoretical basis of the sound-focusing method described herein.

FIG. 2 is a graph which compares two-site signal subtraction to single-site sampling, in one dimension.

FIG. 3 is a logarithmic contour plot of two-site signal subtraction values for sounds of equal intensity originating in the xy plane of the sampling sites.

FIG. 4 is a logarithmic contour plot of the ratio of two-site signal subtraction to single-sampling-site values for sounds originating in the xy plane of the sampling sites.

FIG. 5 is an illustration of sinωt values at the sampling sites of a four-satellite configuration.

FIG. 6 is a logarithmic contour plot of satellite-subtraction method (SSM) values for sounds of equal intensity originating in the xy plane of the sampling sites of the four-satellite configuration of FIG. 5.

FIG. 7 is a logarithmic contour plot of SSM values for sounds of equal intensity originating in the xy plane of the sampling sites of a three-satellite configuration.

FIG. 8 is a logarithmic contour plot of the ratio of SSM to single-sampling-site values for sounds of equal intensity originating in the xy plane of the sampling sites of the four-satellite configuration of FIG. 5.

FIG. 9 is a logarithmic contour plot of SSM values in the xz plane of line DF, for the four-satellite configuration of FIG. 5.

FIG. 10 is a diagram of the compound microphone of the preferred embodiment of the four-satellite configuration of FIG. 5.

FIG. 11 is an electrical schematic diagram of the preferred analog embodiment of the four-satellite configuration of FIG. 5.

FIG. 12 is a circuit board diagram of the preferred analog embodiment of the four-satellite configuration of FIG. 5.

FIG. 13 is an electrical schematic diagram of a simple analog embodiment of the SSM.

### DETAILED DESCRIPTION OF THE INVENTION

Theoretical Basis of the Invention

The satellite-subtraction method (SSM) described herein sharply discriminates between sounds which originate near its reference sampling site, and sounds which originate farther away. To accomplish this, the SSM exploits characteristics of the attenuation of sound with distance.

The intensity of sound is inversely proportional to the square of the distance from its source:
I∝1/d² or I=K/d²
where I is intensity, d is distance, and K is the proportionality constant. Thus the relative intensities 1, 2, and 3 units from the source are 1/1², 1/2², and 1/3², respectively.

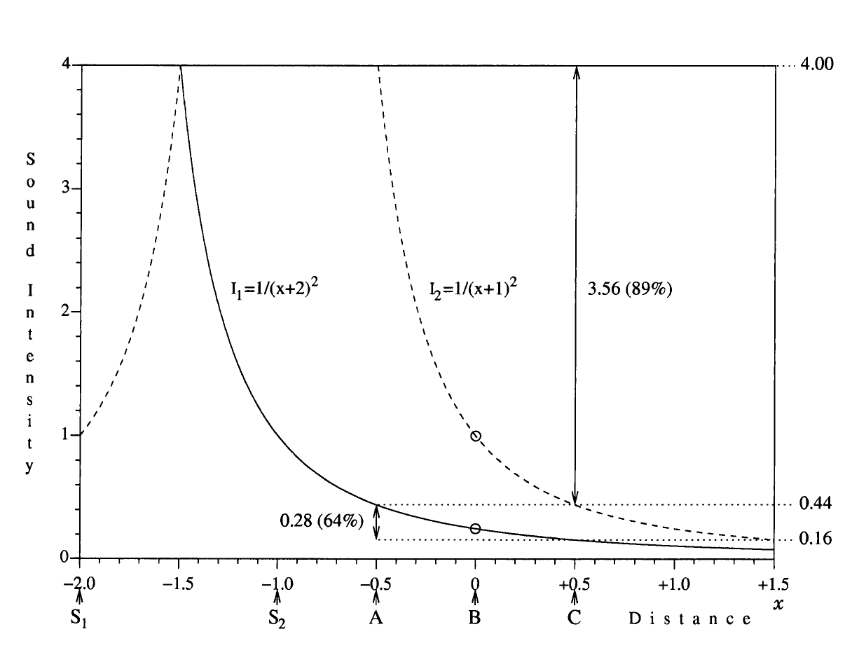

First consider the issue in one dimension (FIG. 1). The distance from a sound source S₁ at x=−2 to a sampling site at x is |−2−x|=x+2 units. The solid curve plots the relative intensity I₁=1/(x+2)² of sound from S₁ at sampling sites from x=−2 to x=1.5. Similarly, for a second sound source S₂ at x=−1, the dashed curve plots the intensity function I₂=1/(x+1)². At a single sampling site B (x=0), the relative intensity of the nearer sound (dashed curve) is 1/(0+1)2=1, while that of the more distant sound (solid curve) is 1/(0+2)²=0.25. At B, the intensity of the nearer sound is therefore 1/0.25=4 times that of the more distant sound. Thus the attenuation of sound due to distance alone substantially differentiates near and distant sounds.

Two-Site Signal Subtraction

Now consider two sampling sites (FIG. 1), a reference site A (x=−0.5) and a satellite site C (x=+0.5). The intensity of the nearer sound (I₂, dashed curve) at A is 1/(−0.5+1)²=4; at C it is 1/(0.5+1)2=0.44. The difference ΔI_{2AC} between the nearer sound's intensities at A and C is 4−0.44=3.56. Subtraction thus preserves 3.56/4=89% of the nearer sound's intensity at A. Similarly, the difference ΔI_{1AC} between the more distant sound's intensities (I₁, solid curve) at the two sampling sites is 0.44−0.16=0.28. Subtraction preserves only 0.28/0.44=64% of the distant sound's intensity at A.

It is clear that the two-site signal subtraction (TSSS) illustrated in this example treats near and distant sounds differently. The ratio of the differences, 3.56/0.28=12.5, is substantially more than the ratio (4) of the intensities sampled at the single site B. It may be said that TSSS discriminates between the near and distant sounds selected for this example 12.5/4=3.125 times as well as single site sampling.

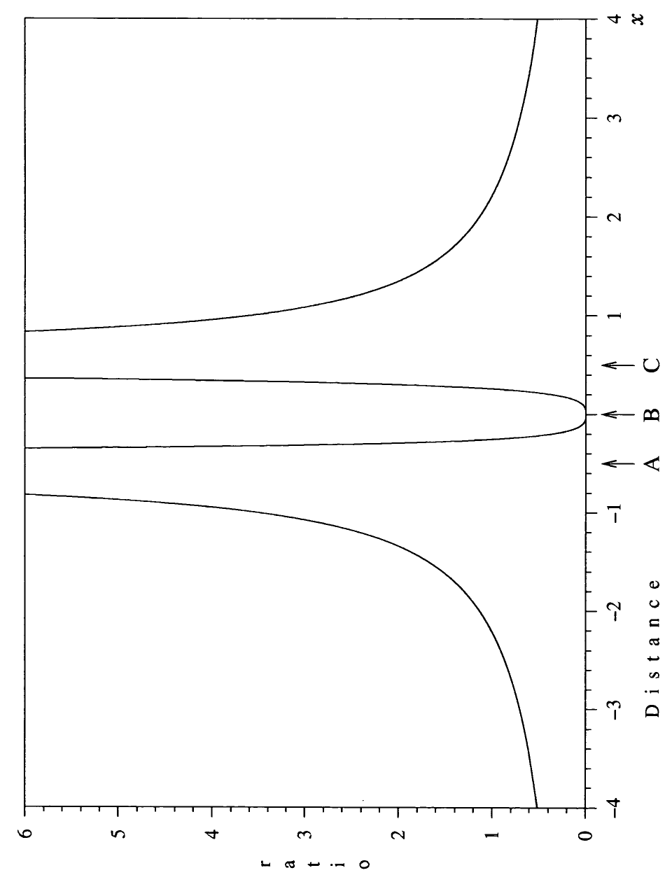

Thus far, we have considered only sound sources located at x=−2 and x=−1. Let us now derive a general formula for the discriminatory improvement afforded by TSSS. In general, the distance from a sound source S (at x_{S}) to a sampling site B (at x=0) is x_{S} units, and the sound's relative intensity at B is I_{B}=1/x_{S}². Similarly, the sound's relative intensity at A (x=−0.5) is I_{A}=1/(x_{S}−0.5)²=1(x_{S}+0.5)², and at C (x=+0.5) it is I_{C}=1/(x_{S}−0.5)². The difference ΔI_{AC} between the sound's intensity at A and C is ΔI_{AC}=I_{A}−I_{C}=1/(x_{S}+0.5)²−1(x_{S}−0.5)². The ratio of this difference to the intensity at B is ΔI_{AC}/I_{B}=[I_{A}−I_{C}]/I_{B}=[1/(x_{S}+0.5)²−1/(x_{S}−0.5)²]/(1/x_{S}²). This is graphed in FIG. 2.

Note that sounds which originate equidistant from A and C (i.e. at the midpoint of \overline{AC}, at B (x=0) in this case) are equally intense at both sites (I_{A}=I_{C}), and are completely eliminated by subtraction ([I_{A}−I_{C}]/I_{B}=0). Other than this dip in the ratio at x=0, it is clear that, compared to the attenuation of sound due to distance alone, TSSS accentuates sounds which originate close to either site (ratio>1 near A and C), while attenuating sounds which originate farther away (ratio<1). It is clear that, in one dimension, two-site signal subtraction improves substantially upon the attenuation of sound with distance, providing a focusing effect.

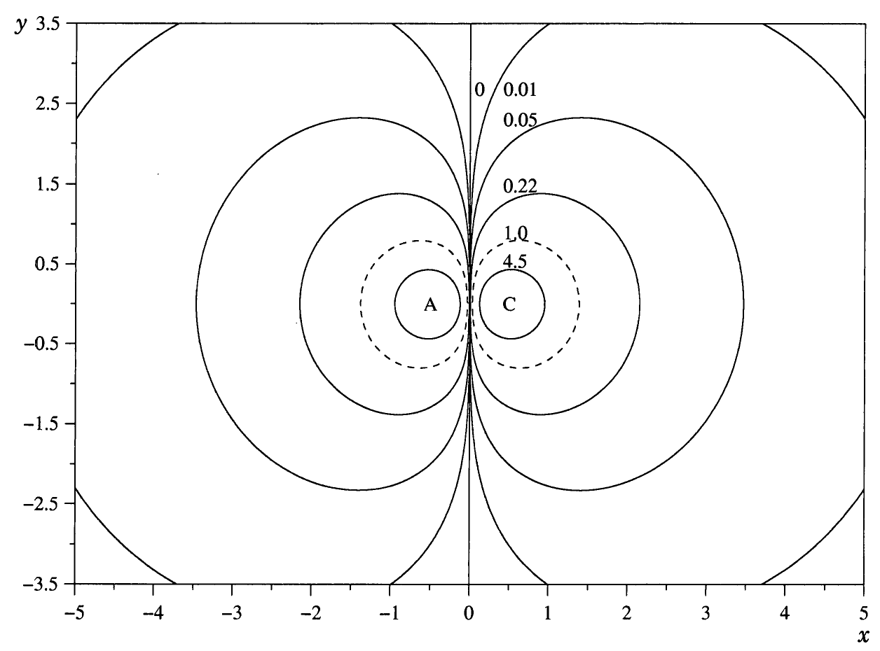

Now consider the issue in two dimensions. The distance d_{SA} from a sound source S, located at (x_{S},y_{S}), to a reference sampling site A, located at (X_{A},Y_{A}), is d_{SA}=[(x_{S}−x_{A})²+(y_{S}−y_{A})/²]^{1/2}. Since the intensity of a sound at a sampling site varies inversely with the square of its distance from the sound's source, the sound's relative intensity at A is I_{A}=1/(d_{SA})=1/([(x_{S}−x_{A})²+(y_{S}−y_{A})²]^{1/2})²=1/[(x_{S}−x_{A})²+(y_{S}−y_{A})²]. The difference ΔI_{AC} between the sound's intensity at A and at a satellite sampling site C (x_{C},y_{C}) is ΔI_{AC}=I_{A}−I_{C}=1/[(x_{S}−x_{A})²+(y_{S}−y_{A})²]−1/[(x_{S}−x_{C})²+(y_{X}−y_{C})²]. FIG. 3 maps ΔI_{AC} for sound sources of equal intensity positioned with respect to sampling sites A (−0.5,0) and C (+0.5,0) in a uniform medium. Note the sharp drop-off in ΔI_{AC} with distance from A or C.

The pattern is the same for any plane which includes line AC. Thus the graph in three dimensions is simply a rotation of FIG. 3 about line AC. Sounds which originate in the plane equidistant from A and C (the “midplane”, x=0 in FIG. 3) are equally intense and in phase at both sampling sites, and cancel one another completely during subtraction (ΔI_{AC}=0).

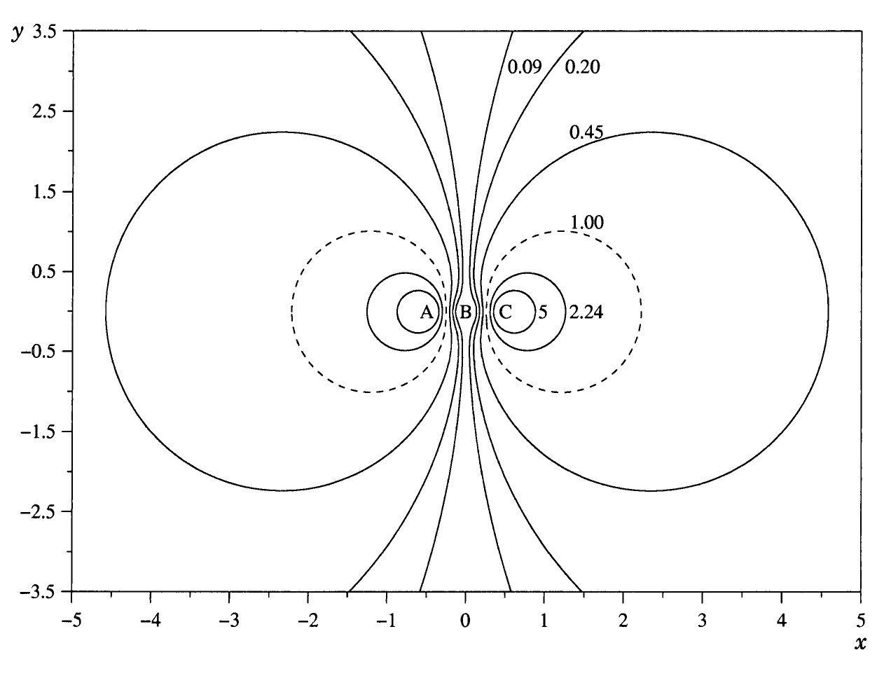

FIG. 4 (a logarithmic contour plot of ΔI_{AC}/I_{B}) compares the extent to which TSSS discriminates between near and distant sounds, to that of a single sampling site B (0,0), positioned midway between TSSS sites A (−0.5, 0) and C (+0.5, 0). Note that TSSS is both more efficient at preserving nearby sounds (ratios>1) and attenuating distant sounds (ratios<1), compared to the single site.

For any reference sampling site A and satellite sampling site C, both the absolute and relative differences between a sound's intensity at the sites decrease as its source moves away (FIGS. 1 and 3). TSSS exploits this to preserve sounds originating close to either site, while attenuating sounds originating farther away.

Two-site signal subtraction has its shortcomings, however, and they relate to the wave nature of sound. If v is the speed of sound, a sound which originates a distance Ad feet closer to one sampling site than the other will reach it Δd/v=Δt seconds sooner. For sources in the midplane (equidistant from sites A and C), Δd=0 and Δt=0. Sounds which originate in the midplane therefore always reach both sampling sites simultaneously, and in phase.

In all other cases, Δd≠0. If Δd is a multiple n of a sound's wavelength λ, Δd=nλ, and Δd/λ=n. When a sound source is a whole wavelength, or a whole multiple thereof, nearer one sampling site than the other, n is a whole number. Sounds of these wavelengths reach the sampling sites in phase, and are subtracted in phase, resulting in cancellation. Sounds for which n+0.5 is a whole number reach the sites 180° out-of-phase, and are subtracted in antiphase. Subtraction of antiphase signals is equivalent to adding in-phase signals. Alternating peaks of cancellation and augmentation produce a frequency-related comb filter effect.

A spatial comb filter effect also plagues the two-site subtraction method. As a source emitting sound of a given wavelength is moved so that Δd changes, n=Δd/λ changes too. Cancellation is maximal when n is a whole number, and augmentation when n+0.5 is a whole number. This produces a pattern of peaks and valleys throughout the sound field for each frequency.

TSSS can be used to dissect a composite of sounds into its components. The first heart sound, for example, is comprised of the closure sounds of the tricuspid and mitral valves. If sampling site A is placed directly over the tricuspid valve, and sampling site C is positioned so that the mitral valve is in the midplane equidistant from A and C (i.e. straddled by them), the sound of the mitral valve is subtracted from the composite. The procedure is reversed to subtract the sound of the tricuspid valve.

Satellite-Subtraction Method

It is possible to improve upon two-site signal subtraction, virtually eliminating both its comb filter effect and falling bass response, while substantially increasing distance selectivity, by adding additional sampling sites. A reference sampling site (positioned as close as possible to a sound source of interest) is designated, and n (≧3) satellite sampling sites are positioned on a circle centered on the reference site, such that they divide the circle into equal arcs. Put another way, n (≧3) satellite sampling sites are positioned at the vertices of an n-sided regular polygon centered on the reference site. The average of the sound intensities sampled at the satellite sites is subtracted from the sound intensity at the reference site, I_{ref}−ΣIₛₐₜₛ/n=ΔIₙ₊₁.

A more detailed analysis of the wave nature of sound is appropriate at this point. Like any periodic waveform, sound can be represented as the sum of sine waves having different amplitudes, frequencies (f), and phase relations. The amplitude L of any one such sine wave at a given sampling site P at a moment in time t is L_{P(t)}=I_{P} sin ωt, where ω, the angular velocity of the sine wave in radians per second, is equal to 2πf. The wave travels from its source S (x_{S}, y_{S}) to P (x_{P}, y_{P}) in t=d_{SP}/v=[(x_{S}−x_{P})²+(y_{S}−y_{P})²]^{1/2}/v seconds. Then L_{P(t)}=I_{P} sin ωt=(1/[(x_{S}−x_{P})²+(y_{S}−y_{P})²]) sin([2πf][(x_{S}−x_{P})²+(y_{S}−y_{P})²] ^{1/2}/v).

Adapting the equation I_{ref}−ΣIₛₐₜₛ/n=ΔIₙ₊₁ to include this sinusoidal variation of sound wave amplitude, it becomes L_{ref(t)}−ΣLₛₐₜₛ₍ₜ₎/n=ΔLₙ₊₁₍ₜ₎. Since all sites are sampled simultaneously, the equation for the time it takes sound to travel from its source to the reference site is used in each term of this equation.

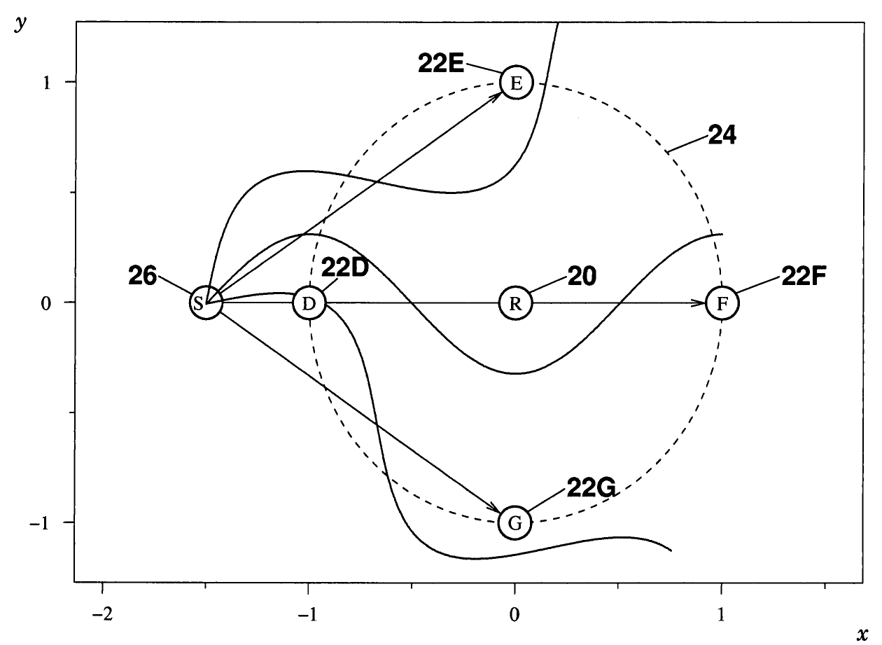

Consider, for example (FIG. 5), a reference sampling site R (0,0) 20, and four satellite sampling sites D (−1,0) 22D, E (0,1) 22E, F (1,0) 22F, and G (0,−1) 22G positioned on a circle 24 centered on R, such that they divide the circle into equal arcs. Sound spreads outward from a source S 26 in all directions (arrows). The value of sin ωt at a moment in time is illustrated for each sampling site. (The declining peak-to-peak value I of each sine wave, which is inversely proportional to the square of the linear distance d from S, is not illustrated.) The amplitude of the sound wave at a given sampling point at a moment in time is given by L_{P(t)}=I_{P} sin ωt. For this example, the pertinent values are:

| Sampling Site | d (from S) | Iₚ = 1/d² | sinωt | Lₚ₍ₜ₎ = Iₚ sinωt |
|---|---|---|---|---|
| R | 1.5 | 0.444 | −1.0 | −0.444 |
| D | 0.5 | 4.0 | 1.0 | 4.0 |
| E | 1.80 | 0.308 | −0.581 | −0.179 |
| F | 2.5 | 0.16 | 1.0 | 0.16 |
| G | 1.80 | 0.308 | −0.581 | −0.179 |

and L_{R(t)}−Σ_{Lsats(t)}/4=ΔL₅₍ₜ₎=−1.395 for the moment in time illustrated.

This example was chosen as a worst-case scenario: S emits sound of wavelength λ=2d_{DR} from a location one-fourth wavelength outside \overline{DF} on line DF. If only reference site R and satellite sites D and F were present, an augmentation peak of ΔL₃₍ₜ₎=−0.444−(4.0+0.16)/2=−2.524 would be produced. The addition of sites E and G adds negative terms to ΣLₛₐₜₛ₍ₜ₎, reducing the peak to −1.395. For comparison, the augmentation peak produced by a prior art two-transducer (D and F) noise-cancelling microphone (embodying TSSS) in a similar worst-case scenario (180° phase mismatch) is 4.16. This illustrates how the addition of satellites substantially reduces the comb filter effect seen with TSSS.

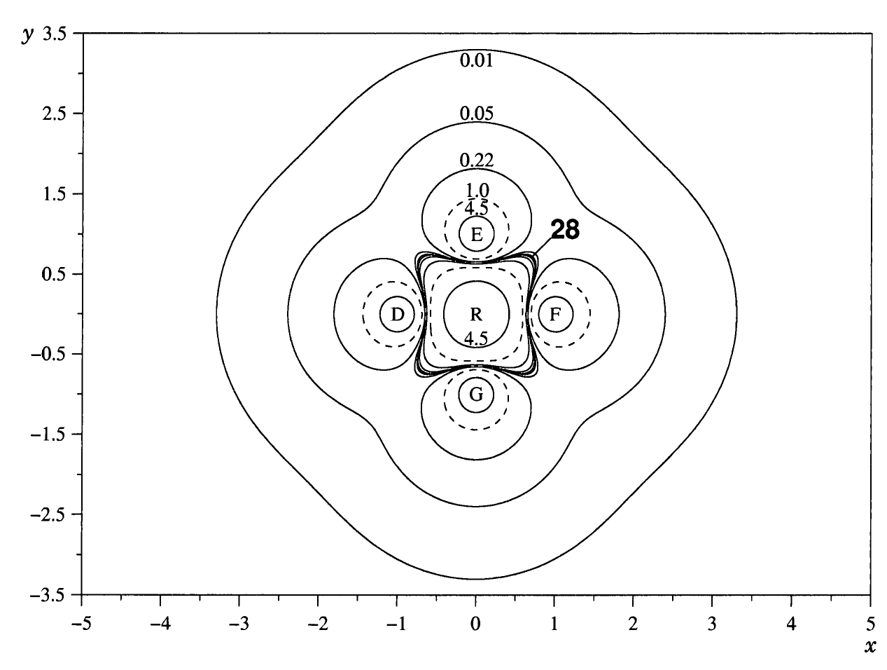

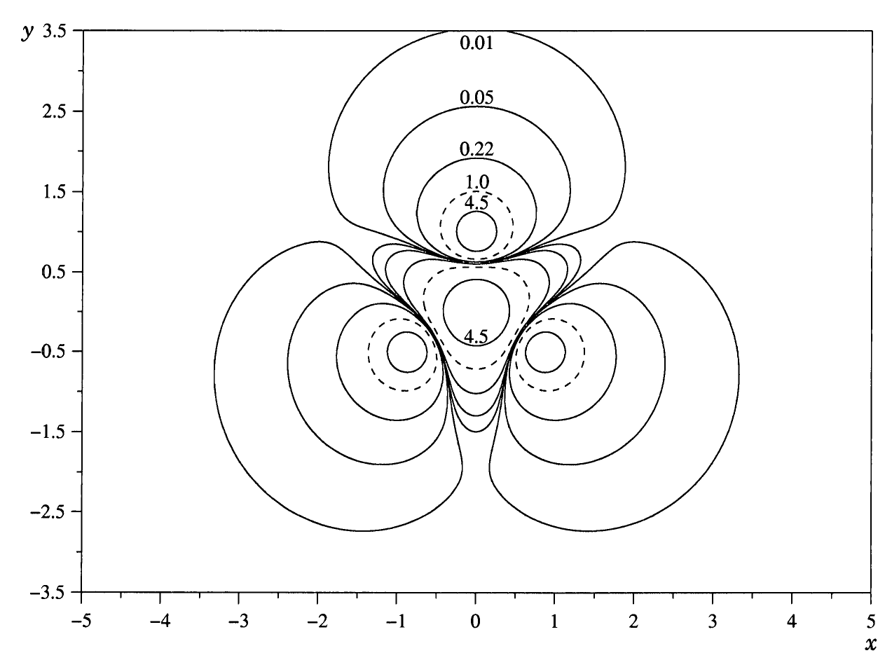

FIG. 6 is a logarithmic contour plot of the absolute wave amplitude |ΔL₅₍ₜ₎| for 200 Hz sound sources with a phase angle of π/2, when v=1,545 m/s (the speed of sound in water at body temperature) and one distance unit equals 2.5 cm. The dashed curves indicate where |ΔL₅₍ₜ₎|=1.0. (Similar conditions and conventions were used for FIGS. 7-9.) Note the conservation of sounds originating near sampling sites D, E, F, G, and R (larger |ΔL₅₍ₜ₎|), and the sharp attenuation of sounds originating farther away (smaller |ΔL₅₍ₜ₎|).

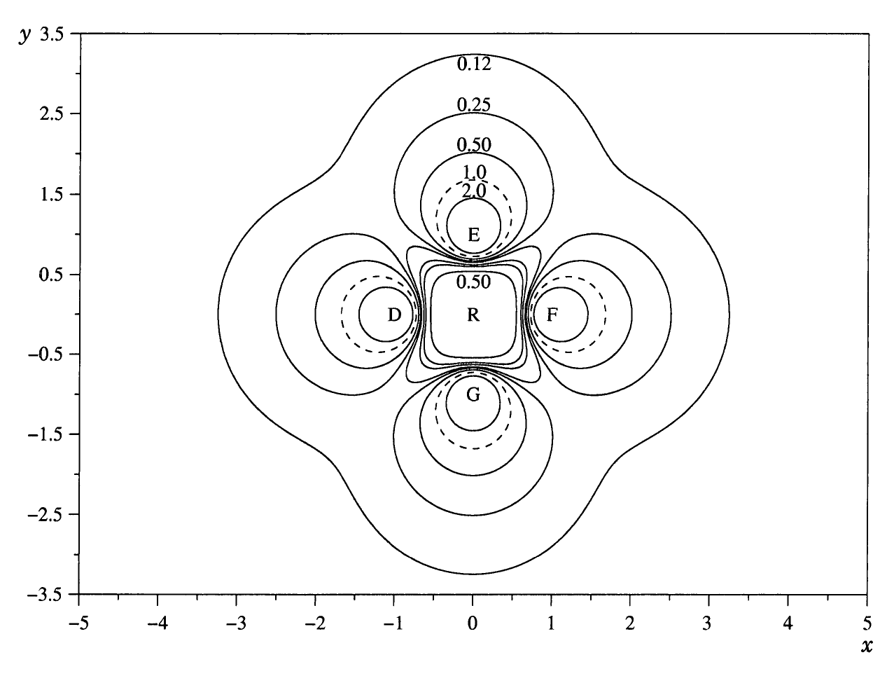

The contours exist in relation to the sampling sites; doubling the distance unit and wavelength modeled results in an identical plot. The pattern shrinks slightly as frequency increases. (For comparison, FIG. 7 is a similar plot of |ΔL₄₍ₜ₎|.) FIG. 8 plots the ratio of |ΔL₅₍ₜ₎| to the absolute wave amplitude sampled at the single site R, |L_{R(t)}|. Note that, compared to single site sampling, the satellite-subtraction method (SSM) is far more efficient at attenuating distant sounds (ratios<1). Sounds which originate very close to the sampling sites, in contrast, are preserved (ratios≧1).

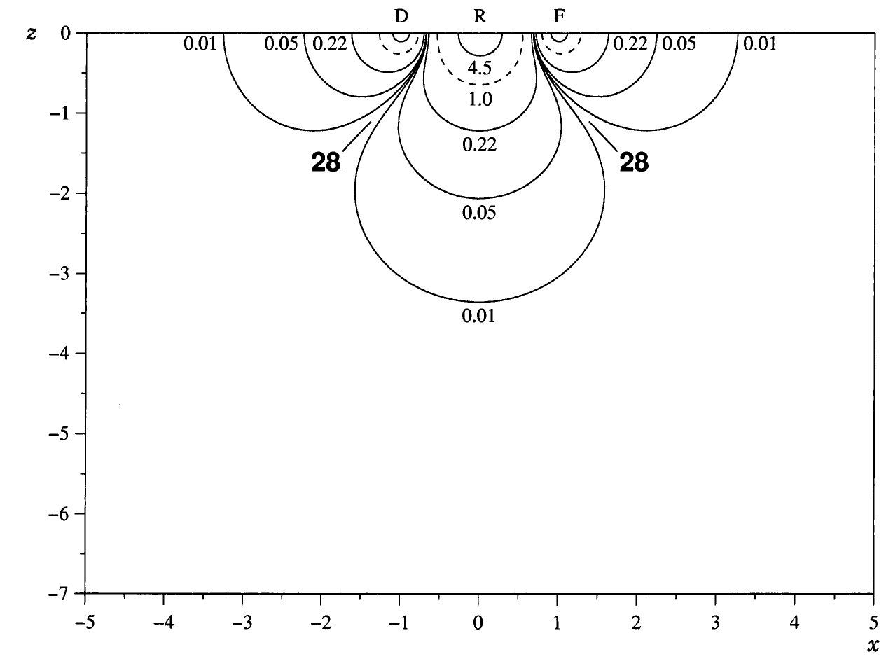

The focusing effect illustrated in two dimensions in FIG. 6 actually occurs in three dimensions. FIG. 9 is a logarithmic contour plot of |ΔL₅₍ₜ₎| in the xz plane of line DF, using the same sampling sites as FIGS. 5, 6, and 8. (The plot is similar in the yz plane of line EG.) Note that when n=4 in L_{ref(t)}−ΣLₛₐₜₛ₍ₜ₎/n=ΔLₙ₊₁₍ₜ₎ sounds which originate very close to the sampling sites (especially the reference site) are preserved, while those originating farther away are sharply attenuated.

In certains situations, a degree of distance selectivity less than that illustrated may be desirable. Dividing ΣLₛₐₜₛ₍ₜ₎ by a number other than n changes the focusing effect; increasing the divisor to infinity makes |ΔLₙ₊₁₍ₜ₎| equal to IL_{ref(t)}, the absolute sound wave amplitude sampled at the single site R. Embodiments which allow the user to continuously vary the divisor provide a continuously variable focusing effect.

Note also in FIGS. 6 and 9 that the zone of cancellation 28 (where I ΔL₅₍ₜ₎|≈0), no longer a simple “midplane”, has taken on a complex shape. Nevertheless, its proximity to the focal zone (higher values of |ΔL₅₍ₜ₎|) makes it possible to listen to the sounds of two juxtaposed sound sources, one at a time. To do so, position the sensing sites so that the sound source under study is in the focal zone, and the source to be eliminated is in the zone of cancellation.

Thus the satellite-subtraction method preserves sounds which originate close to its sampling sites, while sharply attenuating sounds which originate farther away.

It provides greater distance selectivity, throughout the frequency range of human hearing, than was possible with the prior art. It allows the user to listen to the sounds of two juxtaposed sound sources, one at a time. Compared to two-site signal subtraction, it provides a sharper, more targeted, and continuously adjustable focus.

Embodiments

Embodiments of the satellite-subtraction method have acoustic-electrical transducers (e.g. microphones) at the sensing sites, circuitry which accomplishes the required signal processing, and accommodation (e.g. speakers or a connector suitable for speakers) for converting the resulting signal to a form suitable for interpretation. Allowing for the fact that transducers, unlike the sampling sites of the foregoing discussion, have area, the performance of such embodiments, under test conditions in which sound travels in a uniform medium, matches the modeled values. Although only three- and four-satellite configurations were modeled (FIGS. 6 and 7), additional satellite sites may be added, consistent with the method described.

The satellite-subtraction method is suitable for use alone, or in combination with prior art. Cones, baffles, and sound-insulating materials may be used to direct sound from a selected source to or away from a given transducer. Transducers should be selected which are suitable for the sensing environment (e.g. microphones or hydrophones) and the frequencies under study; it is preferred that the satellite transducers be functionally equivalent. The modeling illustrated in figures referenced herein assumes transducers with an omnidirectional pickup pattern, but in some circumstances transducers with other pickup patterns (e.g. cardioid) may be more advantageous.

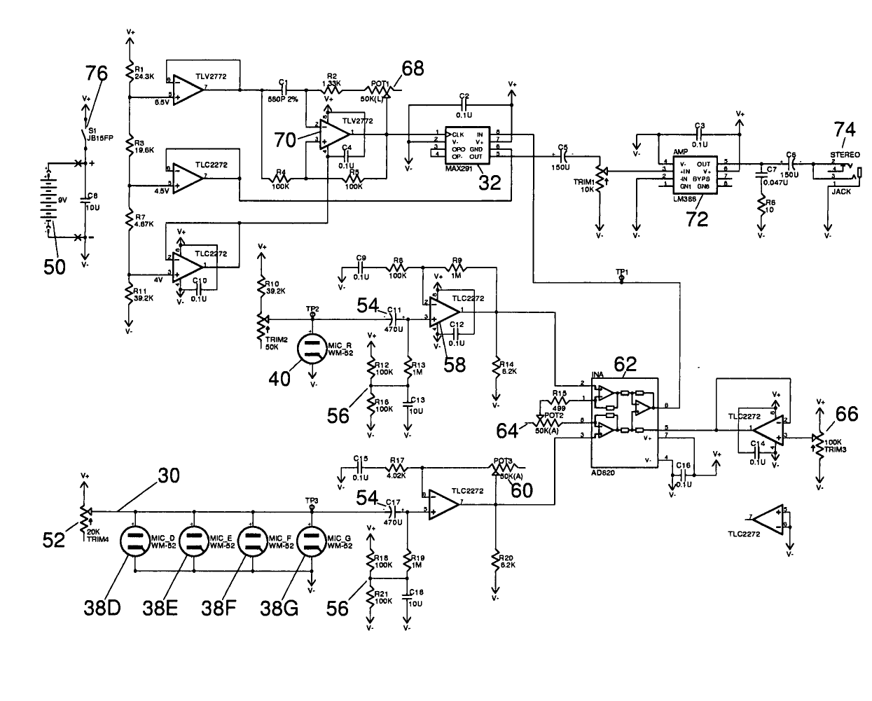

Averaging the signals of the satellite transducers may be accomplished by analog and/or digital addition and division, or by simply connecting them in parallel between a direct current-biased signal wire 30 and system ground (FIG. 11). Filters 32 may be used to shape the SSM's overall frequency response.

Preferred Four-Satellite Embodiment

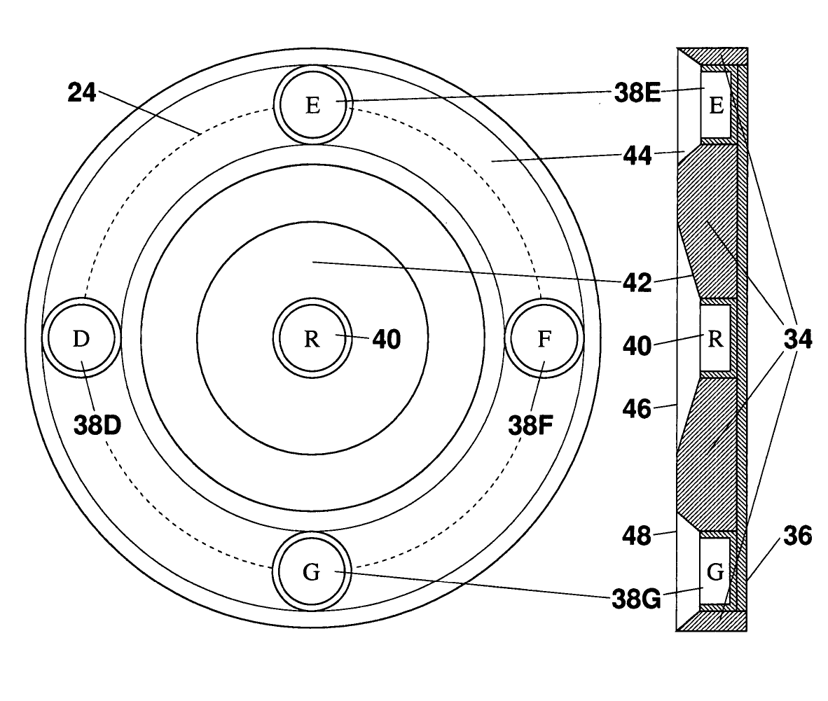

The preferred four-satellite embodiment of the SSM is illustrated in FIGS. 10-12. FIG. 10 depicts a compound microphone consisting of five microphones in a housing 34 on a circuit board 36, and a section through microphones E, R, and G. Satellite microphones (also referred to more generally as satellite transducers) D 38D, E 38E, F 38F, and G 38G are positioned on a circle 24 centered on reference microphone (also referred to more generally as reference transducer) R 40, and divide the circle into equal arcs. A funnel-shaped feature 42 of the housing surrounds, and directs sound to, reference microphone R, while a common trough 44 directs sound to the satellite microphones. Circular 46 and annular 48 diaphragms (not shown in the en face view) with appropriate resonant frequencies may optionally be included to facilitate sound transfer (e.g. at an interface) and to protect the transducers.

A 9-volt battery 50 serves as a source of electrical power (FIG. 11). Identical satellite microphones 38D-G are connected in parallel between a direct current-biased signal wire 30 and ground, an arrangement which automatically averages their signal voltages (i.e. calculates ΣLₛₐₜₛ₍ₜ₎/4). The direct current bias voltage is set to the standard operating voltage of the satellite microphones by adjusting a satellite trimmer potentiometer 52. The reference microphone 40 is similarly connected between its standard operating voltage and ground. Since all of the microphones are connected directly to the circuit board 36 (FIGS. 10 & 12), electromagnetic interference is minimized, and neither balanced microphones nor screened cables are required.

Large-value input capacitors 54 are used to strip the reference and satellite signals from their direct current bias voltages, and voltage dividers 56 are used to rebias the signals midway between V+ and V−. Unfortunately, capacitors attenuate signal components of very low frequency. In some applications, such as medical stethoscopy, these frequencies are often the focus of study. (The dominant frequency of the first heart sound, for example, is just 22.6+9.6 Hz.) It is important to note, therefore, that the capacitors (and rebiasing circuitry) may be omitted if the signal wires are biased to half the system voltage.

An operational amplifier 58 applies a fixed gain of ten to the reference signal, and a focusing control 60 allows the user to apply a gain of zero to ten to the satellite signal. An instrumentation amplifier (INA) 62 is used to subtract the amplified satellite signal from the amplified reference signal, and a volume control 64 determines how much gain is applied to the resulting difference signal. An INA trimmer potentiometer 66 is adjusted to set the reference voltage of the intrumentation amplifier, so that the direct current bias voltage of its output signal is midway between V+ and V−.

A high-order low-pass filter 32, the corner frequency of which the user can select via a filter control 68 (which determines the output frequency of a relaxation oscillator 70), removes high-frequency contaminants from the signals of interest. The frequencies of normal heart sounds, pathologic heart sounds, physiologic fundamentals, and physiologic harmonics fall below 200, 800, 3000, and 6000 Hz, respectively. When corresponding corner frequencies are selected, the MAX291 8th-order low-pass Butterworth filter 32 removes 99, 96, 85, and 70 percent, respectively, of amplified Johnson noise, while preserving the sounds of interest. (A Bessel filter is less efficient at removing Johnson noise, but it maintains the phase relationships of signal components, and may be the better choice when it is essential that those relationships be preserved.)

In applications in which a fixed corner frequency is acceptable, the relaxation oscillator 70, and its supporting circuitry, may be replaced with a single capacitor. (See the MAX291 data sheet.) A fixed corner frequency of 1544 Hz, the high note of a soprano, to 3088 Hz, the second harmonic of that note, would be appropriate in a SSM embodiment configured for voice. A power amplifier 72 passes the filter's output to an external device (e.g. headphones) via an output connector 74. Noise-canceling headphones may be used in high-noise environments.

Operation of the Preferred Four-Satellite Embodiment

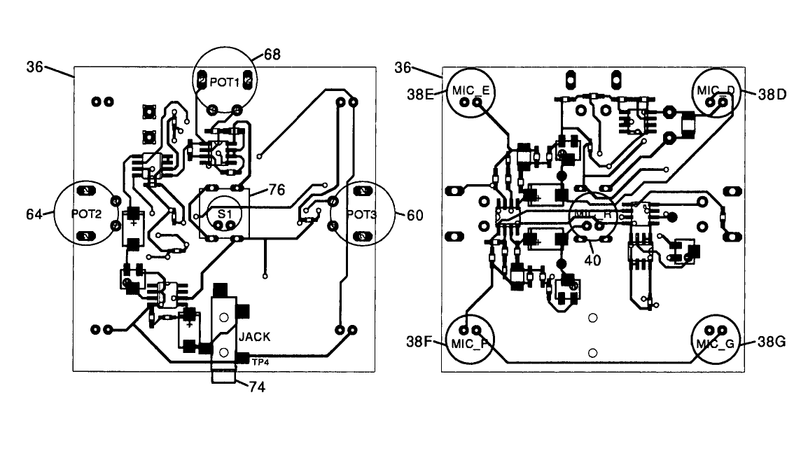

In order to benefit from the advantages of the SSM, users of the preferred four-satellite embodiment must adjust its three thumbwheel potentiometer controls 60 64 68 appropriately. The headphone ear cups are placed over the ears, and the compound microphone (FIG. 10) is positioned close to, and facing, the sound source of interest. It is recommended that the corner frequency (filter control 68, FIGS. 11 and 12) initially be set high, and the focusing control 60 low, so that the sounds presented to the user are most inclusive. The volume control 64 should also initially be set low. The momentary-on power switch 76 is then closed, and the volume is increased to a comfortable level. The user selects particular sounds for further study, and repositions the compound microphone so that its central reference microphone 40 is as close as possible to the source of the sound of interest. The focusing power, corner frequency, and volume may then be adjusted as desired. In general, the volume should be decreased prior to any increase in the corner frequency or decrease in the focusing power.

To listen to the sounds of two juxtaposed sound sources, one at a time, position the compound microphone so that the sound source under study is in the reference microphone's focal zone, and the source to be eliminated is in its zone of cancellation 28 (FIG. 9).

Simple Four-Satellite Embodiment

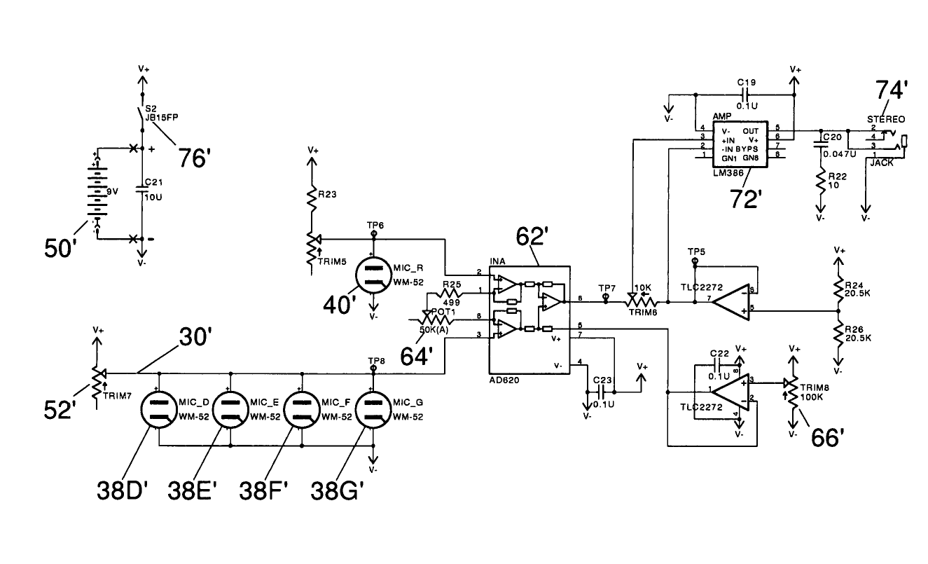

A simple analog four-satellite embodiment of the SSM, with a fixed focus and no filter, may be constructed as diagrammed in FIG. 13. (Primes of the reference numerals used in the preferred embodiment are used for corresponding components in the simple embodiment.) This configuration may be satisfactory for use in a broadcast journalist's microphone, the signal of which will be processed further at the broadcast facility. Note that FIG. 13 further illustrates an embodiment with no capacitors in the signal path, a feature which eliminates the attenuation of low-frequency signal components due to series capacitance.

Applications

The advantages of the SSM suggest a variety of possible applications. In noisy environments, where excellent distance selectivity is desirable, a simple embodiment with a fixed focus and a fixed filter corner frequency (or no filter at all), would improve speech reception and noise rejection. Journalists conducting interviews (and ordinary people using cellular telephones) in noisy crowds, helicopter crews, and combat radiotelephone operators are among possible beneficiaries of this application. (Noise-cancelling headphones may be used in combination with the SSM in particularly noisy environments.)

When sounds of low frequency and low intensity, separated from the sensing means by an interface, are to be discriminated (as in medical stethoscopy), the preferred embodiment is appropriate. The radius of the circle 24 on which the satellite microphones are positioned must be carefully selected, so that the stethoscope has enough depth of focus (FIG. 9), but is not unwieldy. A radius of approximately 3 to 5 cm meets these requirements. Round and annular diaphragms with appropriate resonant frequencies improve sound transfer at the skin interface and protect the microphones. Ideal microphone characteristics are high sensitivity and signal-to-noise ratio, low current consumption, and a flat frequency response down to 16 kHz. Microphones which may be operated at half the system voltage make it possible to omit the input capacitors, limiting the undesirable attenuation of clinically-important signal components of very low frequency. If input capacitors must be used, they should be of high value (e.g. 470 μF). The circuit diagrammed in FIG. 11, with thumbwheel potentiometers (FIG. 12) for the focusing 60, volume 64, and filter 68 controls, may be used. The output connector 74 should be a stereo audio jack, and it is preferred that high-quality headphones be used with the stethoscope.

### Conclusion

All of the electronic components illustrated in the drawings are commercially available. FIGS. 11 and 13 depict the use of AD620 instrumentation amplifiers (manufactured by Analog Devices Incorporated of Norwood Mass.), a MAX291 low-pass filter (manufactured by Maxim Integrated Products of Sunnyvale, Calif.), LM386 power amplifiers (manufactured by National Semiconductor Corporation of Arlington Tex.), and TLC2272 and TLV2772 operational amplifiers (manufactured by Texas Instruments of Dallas, Tex.). One skilled in the art will recognize that other components may be substituted.

While the above description contains many specificities, these should not be construed as limitations on the scope of the invention, but rather as exemplifications of a few possible variations thereof. Many other variations are possible. Accordingly, the scope of the invention should be determined not by the examples illustrated, but by the appended claims and their legal equivalents.

1. A method for transmitting sounds originating close to a site, while sharply attenuating sounds originating farther from said site, comprising the steps of:
(a.) positioning a reference transducer as close as possible to said site,
(b.) positioning three or more satellite transducers, on a circle centered on said reference transducer, such that said satellite transducers divide said circle into equal arcs,
(c.) transducing all sounds reaching each said transducer, to yield a signal from each said transducer,
(d.) averaging said signals from said satellite transducers, to yield an average satellite signal,
(e.) subtracting said average satellite signal, or a portion thereof, from said signal of said reference transducer, to yield a difference signal, and
(f.) converting said difference signal to a form suitable for interpretation, whereby distance selectivity is enhanced, and a focusing effect is achieved.

2. The method of claim 1, wherein said reference transducer and said satellite transducers are microphones.

3. The method of claim 1, wherein positioning said satellite transducers, on said circle centered on said reference transducer, such that said satellite transducers divide said circle into equal arcs, is accomplished by a housing which holds said reference transducer and said satellite transducers in correct relation to one another.

4. The method of claim 3, wherein said housing funnels sound from a central area to said reference transducer, and separately funnels sound from peripheral areas to said satellite transducers via a common trough shared by all said satellite transducers.

5. The method of claim 1, wherein averaging is accomplished by connecting said satellite transducers in parallel between a direct current-biased signal wire and an electrical ground.

6. The method of claim 1, wherein the portion of said average satellite signal, to be subtracted from said reference signal, is continuously adjustable from zero to 100 percent.

7. The method of claim 1, wherein converting said difference signal to a form suitable for interpretation includes functions selected from the group consisting of amplification, filtering, and transduction.

8. A compound microphone, comprising:
(a.) a source of electrical power,
(b.) a reference microphone, which transduces sound to a reference signal,
(c.) three or more satellite microphones, positioned on a circle centered on said reference microphone, such that said satellite microphones divide said circle into equal arcs, each of which said satellite microphones transduces sound to a satellite signal,
(d.) a housing, which maintains said reference microphone and said satellite microphones in correct relation to one another, and
(e.) a signal-processing circuit, which subtracts an average of said satellite signals, or a portion thereof, from said reference signal, yielding a difference signal,
whereby said difference signal is predominately representative of sound originating proximate to said reference microphone, resulting in enhanced distance selectivity, and a focusing effect.

9. The compound microphone of claim 8, wherein said housing funnels sound from a central area to said reference microphone, and separately funnels sound from peripheral areas to said satellite microphones via a common trough shared by all said satellite microphones.

10. The compound microphone of claim 9, wherein said central area is circular and said peripheral areas comprise an annulus concentric with said central area.

11. The compound microphone of claim 10, further including a circular diaphragm which covers said central area, and an annular diaphragm which covers said peripheral areas.

12. The compound microphone of claim 8, wherein said satellite microphones are connected in parallel between a direct current-biased signal wire and an electrical ground, whereby said average of said satellite signals is present on said direct current-biased signal wire.

13. The compound microphone of claim 8, wherein said portion of said average of said satellite signals is continuously adjustable from zero to 100 percent, whereby the distance selectivity function of said compound microphone is continuously adjustable.

14. The compound microphone of claim 8, wherein said signal-processing circuit further amplifies said difference signal.

15. The compound microphone of claim 14, wherein said signal-processing circuit further filters said difference signal.

16. The compound microphone of claim 8, wherein said signal-processing circuit further filters said difference signal.

17. The compound microphone of claim 8, further including an output connector, which transmits said difference signal to an external device,

18. The compound microphone of claim 17, wherein said output connector is an audio jack.

19. The compound microphone of claim 8, further including a speaker, which transduces said difference signal to sound.

20. The compound microphone of claim 8, wherein said signal-processing circuit contains no capacitors in the signal path, whereby attenuation of low-frequency signal components due to series capacitance is eliminated.
